(19) United States
(12) Patent Application Publication
(10) Pub. No.: US 2023/0297852 A1
(43) Pub. Date: Sep. 21, 2023

(54) Multi-Stage Machine Learning Model Synthesis for Efficient Inference

(71) Applicant: Google LLC, Mountain View, CA (US)

(72) Inventors: Li Zhang, Seattle, WA (US); Andrew Gerald Howard, Culver City, CA (US); Brendan Wesley Jou, New York, NY (US); Yukun Zhu, Seattle, WA (US); Mingda Zhang, Pittsburgh, PA (US); Andrey Zhmoginov, Mountain View, CA (US)

(21) Appl. No.: 18/007,379

(22) PCT Filed: Jul. 29, 2021
(86) PCT No.: PCT/US2021/043655

§ 371 Date: Jan. 30, 2023

Related U.S. Application Data
(60) Provisional application No. 63/057,904, filed on Jul. 29, 2020.

(51) Int. Cl. G06N 5/022

(52) U.S. Cl. CPC G06N 5/022

(57) ABSTRACT

Example implementations of the present disclosure combine efficient model design and dynamic inference. With a standalone lightweight model, the unnecessary computation on easy examples is avoided and the information extracted by the lightweight model also guide the synthesis of a specialist network from the basis models. With extensive experiments on ImageNet it is shown that a proposed example BasisNet is particularly effective for image classification and a BasisNet-MV3 achieves 80.3% top-1 accuracy with 290 M MAdds without early termination.

### RELATED APPLICATIONS

This application claims priority to and the benefit of U.S. Provisional Pat. Application No. 63/057,904, filed Jul. 29, 2021. U.S. Provisional Pat. Application No. 63/057,904 is hereby incorporated by reference in its entirety.

### FIELD

The present disclosure relates generally to machine learning. More particularly, the present disclosure relates to a multi-stage process for synthesizing a combined model with improved inference efficiency.

### BACKGROUND

High-accuracy yet low-latency machine learning models (e.g., convolutional neural networks) enable opportunities for on-device machine learning. Such models are playing increasingly important roles in various mobile applications, including but not limited to intelligent personal assistants, AR/VR, and real-time voice translations.

Designing efficient convolutional neural networks especially for edge devices has received significant research attention. Prior research attempted to tackle this challenge from different perspectives, such as novel network architectures, better support from hardware accelerators, or conditional computation and adaptive inference algorithms.

However, focusing on one of such perspectives in isolation may have side effects. For example, novel network architectures may introduce custom operators that are not well-supported by hardware accelerators. Thus, a promising new model may have limited practical improvements on real devices due to a lack of hardware support. Failure to account for multiple perspectives reduces the broader applicability of the resulting system.

### SUMMARY

Aspects and advantages of embodiments of the present disclosure will be set forth in part in the following description, or can be learned from the description, or can be learned through practice of the embodiments.

One example aspect of the present disclosure is directed to a computing system with improved machine learning inference efficiency. The computing system includes one or more processors and one or more non-transitory computer-readable media that store: a machine-learned prediction model configured to receive an input and to process the input to generate both an initial prediction and a plurality of combination values respectively for a plurality of machine-learned basis models; the plurality of machine-learned basis models; and instructions that when executed by the one or more processors cause the computing system to perform operations. The operations include obtaining the input; processing the input with the machine-learned prediction model to generate the initial prediction and the plurality of combination values; and determining whether the initial prediction satisfies one or more confidence criteria. When the initial prediction satisfies the one or more confidence criteria, the operations include providing the initial prediction as an output. When the initial prediction does not satisfy the one or more confidence criteria, the operations include synthesizing, based at least in part on the plurality of combination values, a combined model from the plurality of machine-learned basis models; processing the input with the combined model to generate a final prediction; and providing the final prediction as the output.

Another example aspect of the present disclosure is directed to a computer-implemented method to train machine-learned models. The method includes obtaining, by a computing system comprising one or more computing devices, a training input. The method includes processing, by the computing system, the training input with a machine-learned prediction model to generate a plurality of combination values respectively for a plurality of machine-learned basis models and, optionally, an initial prediction. The method includes synthesizing, by the computing system and based at least in part on the plurality of combination values, a combined model from the plurality of machine-learned basis models. The method includes processing, by the computing system, the training input with the combined model to generate a final prediction. The method includes evaluating, by the computing system, a loss term that compares the final prediction to a ground truth output associated with the training input. The method includes modifying, by the computing system and based at least in part on the loss term, one or more parameters of one or both of: the machine-learned prediction model; or one or more of the machine-learned basis models.

Another example aspect of the present disclosure is directed to a computing system with multi-stage model synthesis. The computing system includes one or more processors and one or more non-transitory computer-readable media that store: a machine-learned prediction model configured to receive an input and to process the input to generate a plurality of combination values respectively for a plurality of machine-learned basis models; the plurality of machine-learned basis models; and instructions that when executed by the one or more processors cause the computing system to perform operations. The operations include obtaining the input; processing the input with the machine-learned prediction model to generate the plurality of combination values; synthesizing, based at least in part on the plurality of combination values, a combined model from the plurality of machine-learned basis models; processing the input with the combined model to generate a final prediction; and providing the final prediction as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example model architecture and process according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

FIG. 3 depicts a flow chart diagram of an example method to perform machine learning model inference according to example embodiments of the present disclosure.

FIG. 4 depicts a flow chart diagram of an example method to perform machine learning model training according to example embodiments of the present disclosure.

Reference numerals that are repeated across plural figures are intended to identify the same features in various implementations.

### DETAILED DESCRIPTION

### Overview

Generally, the present disclosure is directed to a multi-stage process and structure for synthesizing a combined model with improved inference efficiency. In particular, aspects of the present disclosure are directed to model architectures and corresponding processes which, in some instances, can be referred to as “BasisNets”.

The proposed systems and methods provide advancements in efficiency which combine the benefits from multiple perspectives, such as new architectures, conditional computation, and early termination. One example approach according to the present disclosure first uses a lightweight prediction model to process an input (e.g., an input image) and generate combination values (e.g., coefficients), which can later be used to guide the synthesis of a heavier combined model that processes the input to obtain a final output. In some implementations, in addition to the combination values, the lightweight prediction model is also configured to generate an initial prediction. In some implementations, the system can terminate the inference process early if the confidence associated with the initial prediction confidence is sufficiently high, thereby resulting in more efficient inference.

The proposed approaches can be used with any existing network architectures and the two stages can be jointly trained end to end. As described in U.S. Provisional Pat. Application No. 63/057,904, example implementations of a BasisNet were validated on ImageNet classification for MobileNets of different generations and sizes and achieved significant improvements over strong baselines. Without using early termination, an example implementation referred to as BasisNet-MV3 obtained 80.3% accuracy with 290 M Multiply-Adds operations (MAdds). With early termination available, the average cost can be further reduced to 200 M MAdds while maintaining accuracy of 80.0%.

In addition, the proposed design is compatible with existing mobile hardware: the first stage lightweight prediction model can be run on a central processing unit (CPU), while the synthesized combined model in the second stage can be run on more specialized accelerators, if desired.

More particularly, model synthesis is a flexible concept applicable to any novel network architecture that enables advancements in efficient model design. Some example systems and methods of the present disclosure leverage model synthesis design is combination with early termination. For example, some implementations enable users to balance computation budget and accuracy with a single hyperparameter (e.g., a confidence threshold against which the initial prediction confidence is compared).

On the hardware side, the two-stage model synthesis strategy described herein allows the optional execution of the lightweight and synthesized models on different processing units (e.g., CPU, mobile GPUs, accelerators) in parallel to handle streaming data. Any network design can be specified for the synthesized model, so specific hardware restrictions can be accommodated.

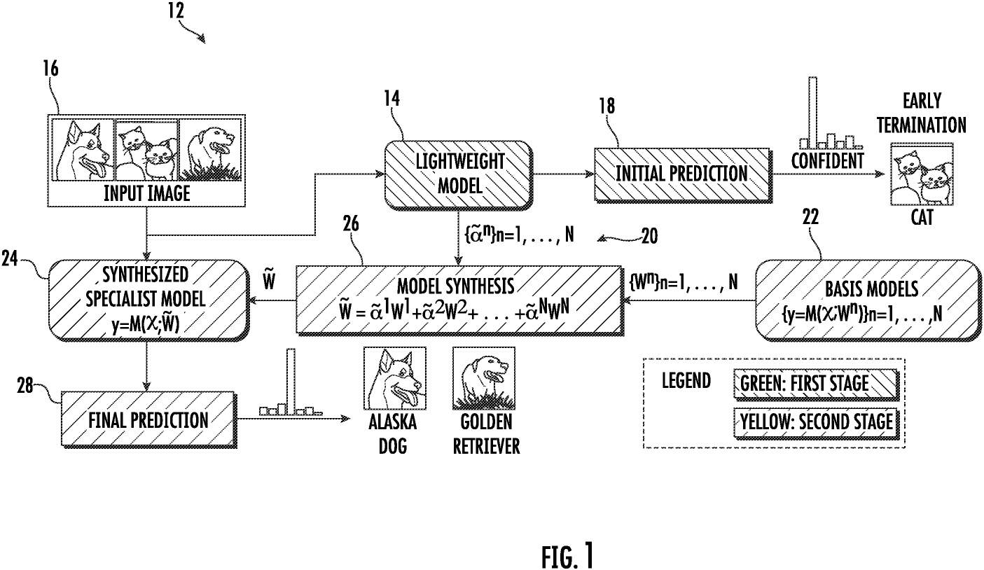

An example overview of an example BasisNet 12 is shown in FIG. 1. Although FIG. 1 uses image classification as an example problem, the proposed systems and methods are applicable to any different machine learning task.

As illustrated in FIG. 1, the example BasisNet 12 has two stages: the first stage includes a lightweight model 14 that processes an input 16 (e.g., in the example the input is an image) and produces both an initial prediction 18 and combination values 20 (e.g., coefficients). In the example, the initial prediction 18 is an initial classification prediction.

In the second stage, the combination values 20 are used to combine a set of basis models 22 into a single combined model 24 to process the input image and generate the final classification result. Specifically, a model synthesis process (shown at 26) can combine the basis models 22 according to the combination values 20 to generate the combined model 24. The combined model 24 can generate a final prediction 28 for the input 16.

In some implementations, the second stage can be skipped if the initial prediction 18 is sufficiently confident (e.g., greater than a threshold confidence value). This can be referred to as ‘early stopping’. Early stopping can result in savings of computational resources such as processor usage, memory usage, etc.

Thus, in FIG. 1, all images go through the lightweight model 14 and depending on the confidence of the initial prediction 18, may be further processed by a synthesized specialist model 24, which is obtained by combining 26 basis models 22 with the combination values 20 generated by the lightweight model 14. Example model synthesis techniques are detailed elsewhere herein.

In some implementations, some or all of the basis models 22 share the same architecture but differ in weight parameters. In some implementations, some of the weights can be shared to avoid overfitting and reduce the total model size. One general idea behind the illustrated example BasisNet is to use dynamic model synthesis 26 to efficiently obtain input-dependent specialist model(s) 24 from the collection of basis models 22. Intuitively, specialists would outperform a general model since they have more domain knowledge, like mixtures of experts.

As described in U.S. Provisional Pat. Application No. 63/057,904, example implementations of BasisNet were validated with different generations and sizes of MobileNets and observed promising improvements. Notably, even without using early termination, example implementations of BasisNet with 16 basis models of MobileNetV3-large only requires 290 M MAdds to achieve 80.3% top-1 accuracy on the ImageNet validation set. Using early termination, the average cost can be further reduced to 200 M MAdds with the top-1 accuracy remaining at 80.0%. Average cost is reduced since easy inputs are only handled by lightweight model; max remains 290 M MAdds.

Thus, the present disclosure proposes an approach that combines efficient neural nets, conditional computation, and early termination in a simple form and demonstrates state-of-the-art accuracy-MAdds trade-off curve on ImageNet. The present disclosure also provides a training method for the new BasisNet architecture, and the training method is also shown to be effective to improve training previous models (e.g., MobileNets and CondConv).

The systems and methods of the present disclosure provide a number of technical effects and benefits. As one example, the systems and methods of the present disclosure provide improved model accuracy at a machine learning task such as, for example, an image classification task or other image processing tasks such as object recognition, object detection, segmentation, etc. Specifically, by using a prediction model to generate input-specific combination values that are used to synthesize a input-specific specialist combined model, the accuracy of the final predictions made by the combined model can be improved.

As another example technical effect and benefit, the systems and methods of the present disclosure can intelligently apply early stopping to the process when an initial prediction made by the lightweight model meets one or more confidence criteria. This early stopping can enable savings of computational resources but is sparingly applied to cases where the initial prediction has high confidence. This provides an ability to achieve computational savings without sacrificing model performance.

As another example technical effect and benefit, the multi-stage model architecture and process described herein can be adapted to or efficiently implemented with mixed hardware. For example, the lightweight model and model synthesis can run on CPU, and once the synthesis completes, the synthesized specialist model can be sent to a hardware accelerator, e.g. Edge TPU, just like a regular static neural network. This can enable easier deployment on existing hardware configurations.

With reference now to the Figures, example embodiments of the present disclosure will be discussed in further detail.

### Example Multi-Stage Model Synthesis Approaches

Some example implementations of the BasisNet have two stages: a first stage lightweight prediction model, and a second stage model synthesis from a set of basis models. The lightweight model can generate two outputs, an initial prediction and basis combination values such as combination coefficients. If the initial prediction is of high confidence, the input data is presumably relatively easier to process and BasisNet can directly output the initial prediction and terminate early. But if the inputs are more complicated, the combination values can be used to guide the synthesis of a specialist combined model from the basis models. The synthesized specialist can be responsible for generating a final prediction.

### Example Lightweight Prediction Models

An example lightweight model is a fully-fledged network with two tasks: (1) generating initial output (e.g., an initial classification prediction) and (2) generating combination coefficients for model synthesis. The first task is a standard task (e.g., classification problem) thus elaboration is provided on the second task below.

Assuming there are N basis models for the second stage and each has K layers, one example set of combination values predicted by the lightweight model can be coefficients α ∈ R^{K×N}

$$α = ϕ \left(\text{LM} \left(f \left(x\right)\right)\right) \qquad \text{(1)}$$

where LM stands for lightweight model and ϕ represents a non-linear activation function (e.g. softmax). Softmax can be used as a default because it enforces convexity, which promotes sparsity and therefore can lead to more efficient implementations. f (x) represents a transformation of the input, and in some cases f(x) = x or f(x) = DownSampling(x).

### Example Basis Model Synthesis Techniques

In some implementations, basis models are a collection of model candidates, which share the same architecture but have different parameters. By combining basis models with different weights, a specialist network can be synthesized. Various alternative designs can be used for building basis models, such as mixture of experts or models with multiple parameter-efficient patches.

One example synthesis technique is as follows: consider a regular deep network M with image input x. Assume the output of the k-th convolutional layer is Oₖ(x) which could be obtained by

$${O}_{k} \left(x\right) = \left(\begin{matrix}ϕ \left({W}_{0} ∗ x\right) , \text{if} k = 0 \\ ϕ \left({W}_{k} ∗ {O}_{k - 1} \left(x\right)\right) , \text{if} k > 0\end{matrix}\right) \qquad \text{(2)}$$

where Wₖ represents the convolution kernel at the k-th layer and * represents a convolution operation. For simplicity some operations like batch normalization and squeeze-and-excitation are omitted from the notation. In some example implementations of BasisNet, the input-specific layer-k kernel W̃ₖ can be synthesized by linearly combining the kernels from N basis models at k-th layer, denoted by

$${\left\{{W}_{k}^{n}\right\}}_{n = 1 , … , N} :$$

$${\tilde{W}}_{k} = {\tilde{α}}_{k}^{1} ⋅ {W}_{k}^{1} + ⋯ + {\tilde{α}}_{k}^{N} ⋅ {W}_{k}^{N} \qquad \text{(3)}$$

where

$${\tilde{α}}_{k}^{n}$$

represents the weight for the k-th layer of the n-th basis. W̃ and α̃ are used to emphasize their dependency on x. This design allows an increase in model capacity but retains the same number of convolution operations. Specifically, when the number of parameters is much less than the number of multiply-adds in a single basis architecture, combining multiple models does not significantly increase the computation cost. As such, optionally using sparse convex coefficients further reduces the combination cost.

Convex combination coefficients can be used. However, two special cases are described:
αₖ is the same for all layers. In this case, the combination is per-model instead of per-layer.
αₖ as an N-dimension vector is one-hot encoded. In this case, synthesis becomes model selection at k-th layer.

One key difference between BasisNet with certain previous techniques is the ability for the model in BasisNet to be synthesized all at once. In particular, in certain prior techniques the combination coefficient at each layer depends on a previous layer output. This results in the model needing to be synthesized on a layer by layer basis.

On the contrary, since BasisNet obtains the coefficients from the lightweight model, the entire specialist model can be synthesized all at once, and BasisNet can be more easily deployed to current hardware. For example, the lightweight model and model synthesis can run on CPU, and once the synthesis completes, the synthesized specialist model can be sent to a hardware accelerator, e.g. Edge TPU, just like a regular static neural network.

Also, the combination coefficients of BasisNet have a global view thanks to the lightweight model; while in certain prior techniques the signals are only local as they come from the previous layer. In addition, BasisNet naturally supports early termination which is infeasible for techniques which proceed with synthesis on a layer by layer basis.

### Example Training Techniques

Example BasisNet techniques described herein significantly increase model capacity, but also increase the risk of overfitting. Standard training procedures used to train MobileNets may, in some situations, lead to overfitting on BasisNet. A few regularization techniques are described which assist in reducing overfitting in a BasisNet.
Basis model dropout (BMD). In BMD, the training system randomly shuts down certain basis model candidates during training. This approach is extremely effective against “experts degeneration” where the controlling model always picks the same few candidates (“experts”).
AutoAugment (AA) AutoAugment (Cubuk et al., 2019) is a search-based procedure for finding specific data augmentation policy towards a target dataset. Replacing the original data augmentation in MobileNets with the ImageNet policy in AutoAugment can significantly improve the model generalizability.
Knowledge distillation showed that using soft targets from a well-trained teacher network can effectively prevent a student model from overfitting. Using distillation to train the BasisNet was found to be very effective.

In addition to these regularizations, a few other tricks assist in properly training a BasisNet. For example, since the lightweight model directly controls how the specialist model is synthesized, any slight changes in the combination coefficients will propagate to the parameter of the synthesized model and finally affect the final prediction. Since the entire BasisNet can be trained from scratch, this is especially troublesome at the early phase when the lightweight model is still ill-trained. To deal with the unstable training, a hyperparameter ε ∈ [0,1] can be introduced to balance between a uniform combination and a predicted combination coefficients from the lightweight model,

$${α}^{′} = ε ⋅ \frac{1}{N} ⋅ {1}^{K \times N} + \left(1 - ε\right) ⋅ α \qquad \text{(5)}$$

When ε = 1 all bases are combined equally while when ε = 0 the synthesis is following the combination coefficients. In practice ε can linearly decay from 1 to 0 in the early phase of training then remain at 0, thus the lightweight model can gradually take over the control of model synthesis. This approach effectively stabilizes training and accelerates convergence.

In some implementations, all models in both stages can be trained together in an end-to-end manner via back-propagation. Note that in some implementations the basis models are not individually trained; Instead, they all receive gradients from the synthesized model. One example total loss that can be used includes two cross-entropy losses for the synthesized model and the lightweight model, respectively, and L2 regularization,

$$\begin{matrix}L = - log P \left(\left(y\right| x ; \tilde{W}\right) + \\ λ \left(- log P \left(\left(y\right| f \left(x\right) ; {W}_{\text{LM}}\right)\right) + \text{Ω} \left({\left\{{W}^{n}\right\}}_{n = 1 , … N} , {W}_{\text{LM}}\right)\end{matrix} \qquad \text{(6)}$$

where λ is the weight for cross-entropy loss from lightweight model (λ = 1 in example experiments), and Ω(·) is L2 regularization loss applied to all model parameters. In some implementations, the lightweight model receives gradients from all terms, while the basis models are only updated by the first term and regularization.

### Example Devices and Systems

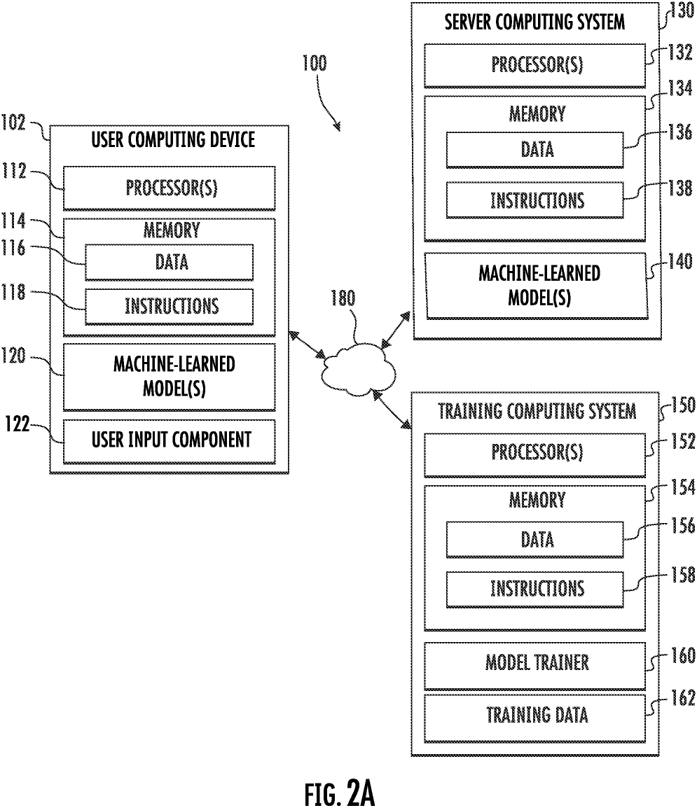

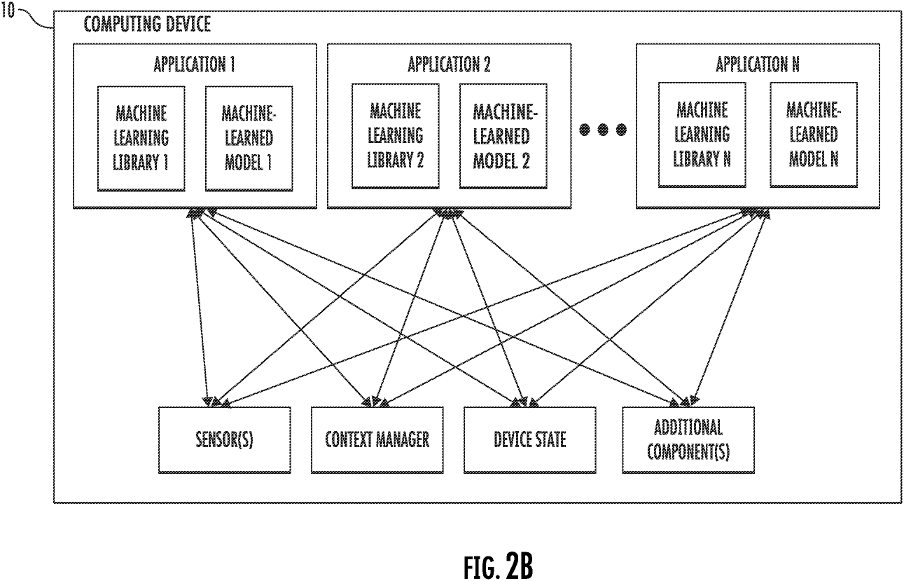

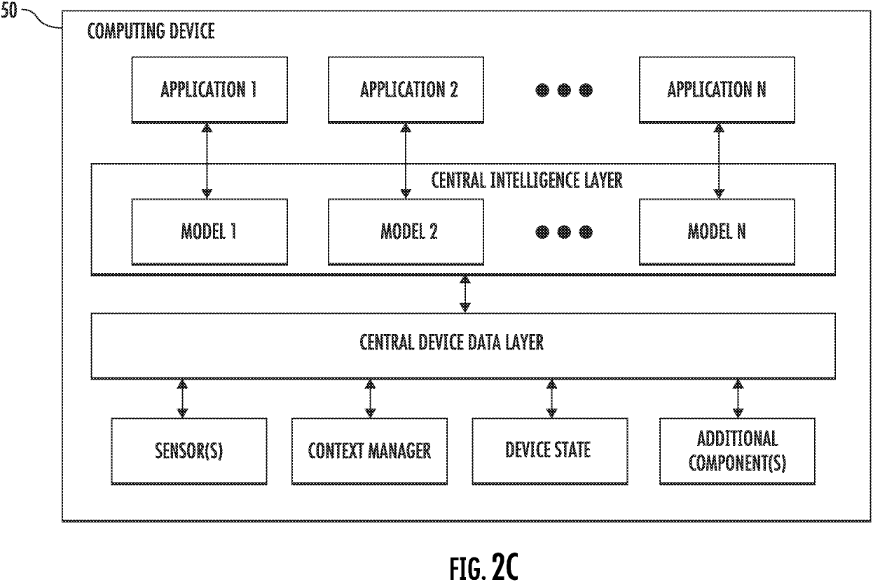

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIG. 1.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel inference across multiple instances of input data).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an inference service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 1.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based at least in part on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based at least in part on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based at least in part on user-specific data.

FIG. 2B depicts a block diagram of an example computing device 10 according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

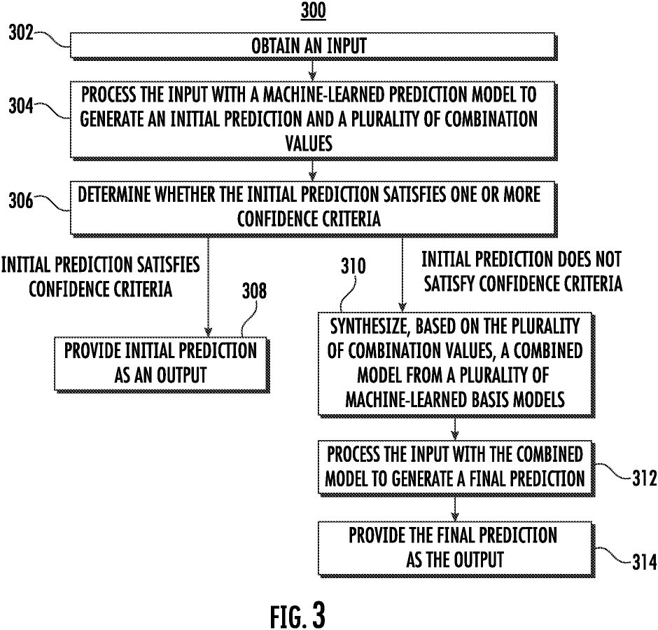

FIG. 3 depicts a flow chart diagram of an example method 300 to perform inference according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain an input.

At 304, the computing system can process the input with a machine-learned prediction model to generate an initial prediction and a plurality of combination values.

At 306, the computing system can determine whether the initial prediction satisfies one or more confidence criteria. In some implementations, determining whether the initial prediction satisfies one or more confidence criteria comprises comparing a confidence score generated by the machine-learned prediction model for the initial prediction to one or more threshold confidence scores.

When at 306 the initial prediction satisfies the one or more confidence criteria, then the method can proceed to 308.

At 308, the computing system can provide the initial prediction as an output.

However when at 306 the initial prediction does not satisfy the one or more confidence criteria, then the method can proceed to 310.

At 310, the computing system can synthesize, based at least in part on the plurality of combination values, a combined model from a plurality of machine-learned basis models.

In some implementations, the plurality of machine-learned basis models comprise a plurality of expert models that were respectively trained on a plurality of different training datasets.

In some implementations, each of the plurality of machine-learned basis models comprises a plurality of layers. In some implementations, for each of the plurality of machine-learned basis models, the machine-learned prediction model is configured to predict a plurality of layer values respectively for the plurality of layers.

In some implementations, each of the plurality of machine-learned basis models comprises one or more kernels. In some implementations, synthesizing, based at least in part on the plurality of combination values, the combined model from the plurality of machine-learned basis models comprises linearly combining the kernels of the plurality of machine-learned basis models according to the plurality of combination values.

At 312, the computing system can process the input with the combined model to generate a final prediction.

At 314, the computing system can provide the final prediction as the output.

In some implementations, processing the input with the machine-learned prediction model consumes relatively fewer computational resources than processing the input with the combined model.

In some implementations, the machine-learned prediction model is a standalone model independent of the plurality of machine-learned basis models.

In some implementations, processing the input with the machine-learned prediction model comprises running the machine-learned prediction model on a central processing unit. In some implementations, processing the input with the combined model comprises running the combined model on or more hardware accelerator units.

In some implementations, the input comprises an image and the output comprises a classification of the image into one or more classes.

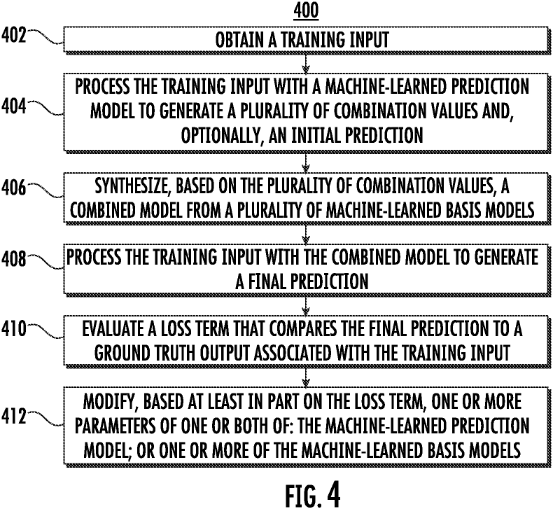

FIG. 4 depicts a flow chart diagram of an example method 400 to perform model training according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain a training input.

At 404, the computing system can process the training input with a machine-learned prediction model to generate a plurality of combination values respectively for a plurality of machine-learned basis models and, optionally, an initial prediction;

At 406, the computing system can synthesize, based at least in part on the plurality of combination values, a combined model from the plurality of machine-learned basis models;

In some implementations, synthesizing, by the computing system and based at least in part on the plurality of combination values, the combined model from the plurality of machine-learned basis models comprises: determining, by the computing system and based on the plurality of combination values, an unevenly combined model from the plurality of machine-learned basis models and mixing, by the computing system and based on a mixing hyperparameter, the unevenly combined model with an equally combined model to produce the combined model.

In some implementations, the method is performed for a plurality of iterations and the mixing hyperparameter decays over the plurality of iterations to provide increased relative influence to the unevenly combined model.

In some implementations, the method 400 further includes randomly eliminating one or more of the plurality of basis models (e.g., during said synthesizing at 406).

In some implementations, the plurality of machine-learned basis models share parameters in some but not all of their layers.

At 408, the computing system can process the training input with the combined model to generate a final prediction;

At 410, the computing system can evaluate a loss term that compares the final prediction to a ground truth output associated with the training input.

At 412, the computing system can modify, based at least in part on the loss term, one or more parameters of one or both of: the machine-learned prediction model; or one or more of the machine-learned basis models.

In some implementations, said modifying at 412 comprises modifying parameters of both the machine-learned prediction model and one or more of the machine-learned basis models.

In some implementations, the method 400 further includes evaluating, by the computing system, a second loss term that compares the initial prediction to the ground truth output associated with the training input; and modifying, by the computing system and based at least in part on the second loss term, one or more parameters of the machine-learned prediction model.

In some implementations, said modifying at 412 comprises: backpropagating, by the computing system, the loss term through the combined model and after backpropagating, by the computing system, the loss term through the combined model, continuing, by the computing system, to backpropagate the loss term through the machine-learned prediction model. In some implementations, the loss can be linearly divided based on the combination values and each portion of the loss can be attributed to a corresponding basis model according to its corresponding combination value.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

A computing system can include one or more non-transitory computer-readable media that store instructions that, when executed, cause the computing system to perform any of the methods described herein. Any operations described herein can be performed as part of a computer-implemented method. Methods or operations can be encoded as computer-readable instructions stored by one or more non-transitory computer-readable media.

What is claimed is:

1. A computing system with improved machine learning inference efficiency, the system comprising:
one or more processors; and
one or more non-transitory computer-readable media that store:
a machine-learned prediction model configured to receive an input and to process the input to generate both an initial prediction and a plurality of combination values respectively for a plurality of machine-learned basis models;
the plurality of machine-learned basis models; and
instructions that when executed by the one or more processors cause the computing system to perform operations, the operations comprising:
obtaining the input;
processing the input with the machine-learned prediction model to generate the initial prediction and the plurality of combination values;
determining whether the initial prediction satisfies one or more confidence criteria;
when the initial prediction satisfies the one or more confidence criteria:
providing the initial prediction as an output; and
when the initial prediction does not satisfy the one or more confidence criteria:
synthesizing, based at least in part on the plurality of combination values, a combined model from the plurality of machine-learned basis models;
processing the input with the combined model to generate a final prediction; and
providing the final prediction as the output.

2. The computing system of claim 1, wherein processing the input with the machine-learned prediction model consumes relatively fewer computational resources than processing the input with the combined model.

3. The computing system of claim 1, wherein determining whether the initial prediction satisfies one or more confidence criteria comprises comparing a confidence score generated by the machine-learned prediction model for the initial prediction to one or more threshold confidence scores.

4. The computing system of claim 1, wherein the plurality of machine-learned basis models comprise a plurality of expert models that were respectively trained on a plurality of different training datasets.

5. The computing system of claim 1, wherein the machine-learned prediction model is a standalone model independent of the plurality of machine-learned basis models.

6. The computing system of claim 1, wherein:
each of the plurality of machine-learned basis models comprises a plurality of layers; and
for each of the plurality of machine-learned basis models, the machine-learned prediction model is configured to predict a plurality of layer values respectively for the plurality of layers.

7. The computing system of claim 1, wherein:
each of the plurality of machine-learned basis models comprises one or more kernels; and
synthesizing, based at least in part on the plurality of combination values, the combined model from the plurality of machine-learned basis models comprises linearly combining the kernels of the plurality of machine-learned basis models according to the plurality of combination values.

8. The computing system of claim 1, wherein:
processing the input with the machine-learned prediction model comprises running the machine-learned prediction model on a central processing unit; and
processing the input with the combined model comprises running the combined model on or more hardware accelerator units.

9. The computing system of claim 1, wherein the input comprises an image and the output comprises a classification of the image into one or more classes.

10. A computer-implemented method to train machine-learned models, the method comprising:
obtaining, by a computing system comprising one or more computing devices, a training input;
processing, by the computing system, the training input with a machine-learned prediction model to generate a plurality of combination values respectively for a plurality of machine-learned basis models and, optionally, an initial prediction;
synthesizing, by the computing system and based at least in part on the plurality of combination values, a combined model from the plurality of machine-learned basis models;
processing, by the computing system, the training input with the combined model to generate a final prediction;
evaluating, by the computing system, a loss term that compares the final prediction to a ground truth output associated with the training input; and
modifying, by the computing system and based at least in part on the loss term, one or more parameters of one or both of:
the machine-learned prediction model; or
one or more of the machine-learned basis models.

11. The computer-implemented method of claim 10, wherein said modifying comprises modifying parameters of both the machine-learned prediction model and one or more of the machine-learned basis models.

12. The computer-implemented method of claim 10, wherein the method further comprises:
evaluating, by the computing system, a second loss term that compares the initial prediction to the ground truth output associated with the training input; and
modifying, by the computing system and based at least in part on the second loss term, one or more parameters of the machine-learned prediction model.

13. The computer-implemented method of claim 10, wherein synthesizing, by the computing system and based at least in part on the plurality of combination values, the combined model from the plurality of machine-learned basis models comprises:
determining, by the computing system and based on the plurality of combination values, an unevenly combined model from the plurality of machine-learned basis models; and
mixing, by the computing system and based on a mixing hyperparameter, the unevenly combined model with an equally combined model to produce the combined model.

14. The computer-implemented method of claim 13, wherein:
the method is performed for a plurality of iterations; and
the mixing hyperparameter decays over the plurality of iterations to provide increased relative influence to the unevenly combined model.

15. The computer-implemented method of claim 10, wherein the method further comprises:
randomly eliminating one or more of the plurality of basis models.

16. The computer-implemented method of claim 10, wherein the plurality of machine-learned basis models share parameters in some but not all of their layers.

17. The computer-implemented method of claim 10, wherein said modifying comprises:
backpropagating, by the computing system, the loss term through the combined model; and
after backpropagating, by the computing system, the loss term through the combined model, continuing, by the computing system, to backpropagate the loss term through the machine-learned prediction model.

18. A computing system with multi-stage model synthesis, comprising
one or more processors; and
one or more non-transitory computer-readable media that store:
a machine-learned prediction model configured to receive an input and to process the input to generate a plurality of combination values respectively for a plurality of machine-learned basis models;
the plurality of machine-learned basis models; and
instructions that when executed by the one or more processors cause the computing system to perform operations, the operations comprising:
obtaining the input;
processing the input with the machine-learned prediction model to generate the plurality of combination values;
synthesizing, based at least in part on the plurality of combination values, a combined model from the plurality of machine-learned basis models;
processing the input with the combined model to generate a final prediction; and
providing the final prediction as an output.

19. (canceled)

20. The computing system according to claim 18, wherein the input comprises an image and the output comprises a classification of the image into one or more classes.
